(19) United States
(12) Patent Application Publication
(10) Pub. No.: US 2025/0234268 A1
(43) Pub. Date: Jul. 17, 2025

(54) DATA TRANSMISSION METHOD AND RELATED DEVICE

(71) Applicant: Tencent Technology (Shenzhen) Company Limited, Shenzhen (CN)

(72) Inventors: Wei WU, Shenzhen (CN); Weike Zheng, Shenzhen (CN); Zan Yang, Shenzhen (CN); Ruilong Chen, Shenzhen (CN)

(73) Assignee: Tencent Technology (Shenzhen) Company Limited, Shenzhen (CN)

(21) Appl. No.: 19/095,144

(22) Filed: Mar. 31, 2025

Related U.S. Application Data
(63) Continuation of application No. PCT/CN2024/073174, filed on Jan. 19, 2024.

(30) Foreign Application Priority Data
Apr. 7, 2023 (CN) 202310394508.3

(51) Int. Cl. H04W 40/12; H04L 43/0829

(52) U.S. Cl. CPC H04W 40/12; H04L 43/0829

(57) ABSTRACT

A data transmission method, performed by a terminal, includes obtaining a network path list including network paths of the terminal, based on the terminal determining to transmit target data to a server via a first network path of the network paths, wherein the network paths correspond to network interfaces that are enabled on the terminal; determining network qualities corresponding to the network paths; determining a second network path from the network path list according to the network qualities, wherein one network quality corresponding to the second network path satisfies a data transmission condition; and transmitting the target data to the server via the second network path.

### CROSS-REFERENCE TO RELATED APPLICATIONS

This application is a continuation application of International Application No. PCT/CN2024/073174 filed on Jan. 19, 2024, which claims priority to Chinese Patent Application No. 202310394508.3 filed with the China National Intellectual Property Administration on Apr. 7, 2023, the disclosures of each being incorporated by reference herein in their entireties.

### FIELD

The disclosure relates to the field of communication technologies, and to a data transmission technology.

### BACKGROUND

With continuous development of communication technologies, requirements for data communication between a terminal and a server are increasingly enlarged.

When the terminal performs data communication with the server, a communication connection may be established between the terminal and the server based on a data transmission protocol. The terminal may exchange data with the server through a network path corresponding to a network interface, to implement data communication.

However, a data transmission mode may have low data transmission quality.

### SUMMARY

According to an aspect of the disclosure, a data transmission method, performed by a terminal, includes obtaining a network path list including a plurality of network paths of the terminal, based on the terminal determining to transmit target data to a server via a first network path of the plurality of network paths, wherein the plurality of network paths correspond to network interfaces that are enabled on the terminal; determining a plurality of network qualities corresponding to the plurality of network paths; determining a second network path from the network path list according to the plurality of network qualities, wherein one network quality corresponding to the second network path satisfies a data transmission condition; and transmitting the target data to the server via the second network path.

According to an aspect of the disclosure, a data transmission apparatus, configured to perform as a terminal, includes at least one memory configured to store computer program code; and at least one processor configured to read the program code and operate as instructed by the program code, the program code includes obtaining code configured to cause at least one of the at least one processor to obtain a network path list including a plurality of network paths of the terminal, based on the terminal determining to transmit target data to a server via a first network path of the plurality of network paths, wherein the plurality of network paths correspond to network interfaces that are enabled on the terminal; first determining code configured to cause at least one of the at least one processor to determine a plurality of network qualities corresponding to the plurality of network paths; second determining code configured to cause at least one of the at least one processor to determine a second network path from the network path list according to the plurality of network qualities, wherein one network quality corresponding to the second network path satisfies a data transmission condition; and transmission code configured to cause at least one of the at least one processor to transmit the target data to the server via the second network path.

According to an aspect of the disclosure, a non-transitory computer-readable storage medium, storing computer code which, when executed by at least one processor, causes the at least one processor to at least obtain a network path list including a plurality of network paths of a terminal, based on the terminal determining to transmit target data to a server via a first network path of the plurality of network paths, wherein the plurality of network paths correspond to network interfaces that are enabled on the terminal; determine a plurality of network qualities corresponding to the plurality of network paths; determine a second network path from the network path list according to the plurality of network qualities, wherein one network quality corresponding to the second network path satisfies a data transmission condition; and transmit the target data to the server via the second network path.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an application scene of a data transmission method according to some embodiments.

FIG. 2 is a flowchart of a data transmission method according to some embodiments.

FIG. 3 is a schematic diagram of execution logic of a data transmission method according to some embodiments.

FIG. 4 is a schematic diagram of a protocol hierarchy of a TCP and a QUIC protocol according to some embodiments.

FIG. 5 is a schematic diagram of a system architecture of an AXP-QUIC according to some embodiments.

FIG. 6 is a structural diagram of a data transmission apparatus according to some embodiments.

FIG. 7 is a structural diagram of a terminal according to some embodiments.

FIG. 8 is a structural diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

With continuous development of terminal technologies, a plurality of wireless access technologies are integrated. A terminal may have a plurality of network interfaces, for example, a wireless fidelity (WiFi) network interface, a wired network interface, and a cellular network interface. Different network interfaces correspond to different network paths.

During data transmission, a network path for data transmission may be selected from network paths corresponding to the terminal. Then data is transmitted to a server by using the selected network path. In the process of transmitting data by using the selected network path, no attention is paid to a change status of a data transmission performance of the selected network path. In this data transmission mode, once the data transmission performance of the selected network path deteriorates, the data transmission quality may be reduced. For example, data transmission efficiency may be reduced, or even data transmission may fail. For example, in a process of performing data transmission by using a network path corresponding to a WiFi network interface, the data transmission efficiency is reduced due to deterioration of the data transmission performance caused by weakening of a WiFi signal, and the deterioration of the data transmission performance caused by disconnection of the WiFi signal directly causes data transmission failure. The data transmission mode may have low data transmission quality in the data transmission process.

Some embodiments provide a data transmission method and a related apparatus. In a process of transmitting, by a terminal, target data to a server using a first network path, a network path adaptive decision method based on a network quality is provided. In a process of transmitting, by a terminal, target data to a server using a first network path, network qualities respectively corresponding to a plurality of network paths of the terminal may be first determined, to evaluate data transmission performances of the plurality of network paths. A second network path satisfying a data transmission condition is determined from the plurality of network paths based on the network quality, and the target data is transmitted by using the second network path. In a data transmission process, a network path for transmitting data may be adaptively decided based on the network quality of each network path, to ensure that data can be transmitted by using a network path satisfying a data transmission condition, thereby improving data transmission quality.

In an actual data transmission process, once the first network path that is originally used cannot satisfy the data transmission condition, the second network path that satisfies the data transmission condition may be used instead, to avoid a problem of poor data transmission quality caused by continuing to use the first network path for transmission, thereby ensuring the data transmission quality.

The data transmission method provided in some embodiments may be implemented by using a computer device. The computer device may be a terminal or a server. The server may be an independent physical server, may be a server cluster or a distributed system including a plurality of physical servers, or may be a cloud server providing a cloud computing service. The terminal includes but is not limited to a smartphone, a computer, an intelligent voice interaction device, a smart home appliance, an in-vehicle terminal, and the like. The terminal and the server may be directly or indirectly connected in a wired or wireless communication mode. However, the disclosure is not limited thereto. Some embodiments may be applied to various scenes, including but not limited to a cloud technology, artificial intelligence (AI), intelligent transportation, and assisted driving. Some embodiments may be applied to a data transmission scene, for example, a data transmission scene in which data is transmitted between the terminal and the server.

In some embodiments, relevant data such as user information is involved in the data transmission process. When some embodiments are applied to a product or technology, a permission or consent of a user may be used, and collection, use, and processing of the relevant data should comply with relevant laws, regulations, and standards of relevant countries and regions.

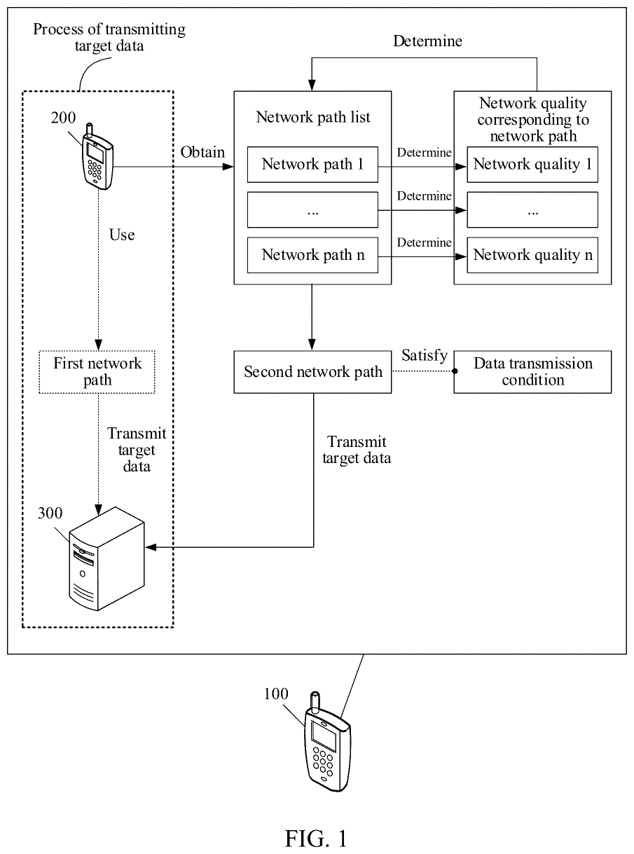

FIG. 1 is a schematic diagram of an application scene of a data transmission method according to some embodiments. The scene shown in FIG. 1 includes a terminal 100, a terminal 200, and a server 300. The terminal 100 may be used as the foregoing computer device. The terminal 200 is a terminal performing data transmission with the server 300. The terminal 100, the terminal 200, and the server 300 may be directly or indirectly connected in a wired or wireless communication mode, so that the terminal 100 may perform the data transmission method provided in some embodiments. During data transmission, a communication connection (for example, a network connection) may be established between the terminal 200 and the server 300. Based on the communication connection therebetween, the terminal 200 may transmit data to the server 300. The smartphone shown in FIG. 1 is used as an example of the terminal 100 and the terminal 200, and is not limited thereto.

With reference to the scene shown in FIG. 1, an example in which the terminal 100 is used as the foregoing computer device is used for describing the data transmission method provided in some embodiments.

First, in FIG. 1, an example in which data transmitted by the terminal 200 to the server 300 is target data is used. A part identified by a dashed box may be configured for representing a process of transmitting the target data, which may refer to a process in which the terminal 200 transmits the target data to the server 300 by using a first network path. In this process, the terminal 100 may obtain a network path list of the terminal 200. The network path list may include a plurality of network paths, for example, may include a network path 1, . . . , and a network path n. The plurality of network paths may include the first network path, and the plurality of network paths are network paths corresponding to network interfaces that are already enabled on the terminal 200. The plurality of network paths in the network path list may all be configured for supporting the terminal 200 to transmit the target data to the server 300.

The terminal 100 may determine a network quality corresponding to each network path in the network path list. The network quality may be configured for representing a data transmission performance of the network path. For example, a network quality 1 corresponding to the network path 1 is determined, . . . , and a network quality n corresponding to the network path n is determined. The data transmission performances of a plurality of network paths may be evaluated by using the network qualities.

Next, the terminal 100 may determine a second network path from the network path list according to the network quality corresponding to each network path in the network path list. The network quality corresponding to the second network path satisfies the data transmission condition. The data transmission condition is configured for evaluating whether the data transmission performance of the network path can ensure the data transmission quality. The second network path satisfying the data transmission condition indicates that the data transmission performance of the second network path may ensure the data transmission quality.

Finally, the terminal 100 may transmit the target data by using the second network path through the terminal 200. The terminal 200 transmits the target data to the server 300 by using the second network path.

It can be seen that in a process of transmitting, by the terminal 200, the target data to the server 300 using the first network path, the terminal 100 makes a network path adaptive decision based on the network quality corresponding to each network path of the terminal 200. The terminal 100 may first determine network qualities corresponding to a plurality of network paths of the terminal 200, to evaluate data transmission performances of the plurality of network paths. A second network path satisfying a data transmission condition is determined from the plurality of network paths based on the network quality, and the terminal 200 transmits the target data by using the second network path. The terminal 200 performs data transmission by using a network path satisfying a data transmission condition, thereby improving data transmission quality.

In an actual application, a software development kit (SDK) may be developed, and then the SDK is used to implement the data transmission method provided to make a network path adaptive decision in a data transmission process. The SDK may be flexibly built in a terminal for data transmission, to implement some embodiments. The terminal 200 is used as an example. If the terminal 200 can support a built-in SDK, the SDK may be correspondingly built in the terminal 200. At this moment, the terminal 100 may be the terminal 200. If the terminal 200 does not support a built-in SDK, to adjust, by using the network path adaptive decision method provided a network path used when the terminal 200 transmits data, the terminal 100 having an SDK function may be used to achieve this objective. At this moment, the terminal 100 may be different from the terminal 200. In a process in which the terminal 200 and the server 300 transmit data, the terminal 100 performs the data transmission method provided to achieve an objective of making a network path adaptive decision for the terminal 200.

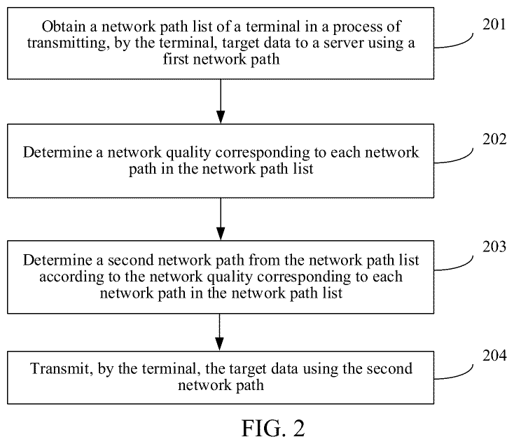

FIG. 2 is a flowchart of a data transmission method according to some embodiments. The data transmission method provided in some embodiments is implemented by, for example, a computer device. The method includes operations 201 to 204.

201: Obtain a network path list of a terminal in a process of transmitting, by the terminal, target data to a server using a first network path.

In an actual application, during data transmission, a communication connection may be established between the terminal and the server. Based on the communication connection therebetween, the terminal may perform data transmission with the server. In a data transmission process, a network path adaptive decision may be made by using the data transmission method provided in some embodiments.

When the terminal is to transmit data to the server, the terminal may enable network interfaces. Network paths corresponding to the enabled network interfaces may be configured for data transmission. When determining to transmit data to the server, the terminal may use the data transmitted by the terminal to the server as target data, and determine a first network path from the network paths corresponding to the enabled network interfaces. The terminal may transmit the target data to the server by using the first network path.

In the process of transmitting, by the terminal, the target data to the server using the first network path, to implement better network transmission quality based on adaptive decision-making for network paths, the computer device may obtain a network path list of the terminal. The network path list includes a plurality of network paths. The plurality of network paths included in the network path list are network paths corresponding to network interfaces that are already enabled on the terminal, including the first network path currently configured for transmitting the target data. For example, the terminal has three network interfaces: a WiFi network interface, a wired network interface, and a Cellular interface. When all the three network interfaces are enabled, the plurality of network paths included in the network path list may include three network paths: a WiFi network path, a wired network path, and a Cellular network path.

202: Determine a network quality corresponding to each network path in the network path list.

After determining a network path list of the terminal, for each network path in the network path list, the computer device may determine a network quality corresponding to the network path. The network quality may be configured for representing a data transmission performance of the network path. The data transmission performances of the plurality of network paths may be evaluated by using the network qualities respectively corresponding to the plurality of network paths, to facilitate subsequent operations of making a network path adaptive decision.

The disclosure does not limit the mode of determining the network quality corresponding to the network path. The following descriptions are merely provided as examples.

In a scene of data transmission by using a network path, a network quality parameter may be set as an index for reflecting the data transmission performance of the network path, to objectively evaluate the network path. In some embodiments, for each network path in the network path list, the computer device may obtain a network quality parameter of the network path, and further may determine, according to the network quality parameter of the network path, a network quality corresponding to the network path. The index of the network path, for example the network quality parameter, may be quantified, and is uniformly converted into the network quality, so that the data transmission performances of the plurality of network paths may be objectively evaluated, compared, and the like based on information of a same type.

The mode of determining, according to the network quality parameter, the network quality corresponding to the network path, is not limited. In an actual application, a network quality evaluation model may be established in advance, and then the obtained network quality parameter may be input into the network quality evaluation model. The input network quality parameter is quantized by using the network quality evaluation model, to determine the network quality. The mode of evaluating the network quality according to the network quality parameter by using the network quality evaluation model is beneficial to improving efficiency of determining the network quality and ensuring accuracy of the determined network quality.

The network quality parameter is used as an index for reflecting a data transmission performance of a network path. A setting thereof is not limited.

The quantity of network quality parameters may be set according to a requirement for evaluation accuracy of the data transmission performance. If the requirement on the evaluation accuracy of the data transmission performance is relatively low, a relatively small quantity of network quality parameters may be set. The data transmission performance of the network path is evaluated more conveniently based on relatively few indexes. If the requirement on the evaluation accuracy of the data transmission performance is relatively high, a relatively large quantity of network quality parameters may be set. The data transmission performance of the network path is evaluated more comprehensively and accurately based on relatively abundant indexes.

For setting content of the network quality parameter, a related index that can reflect the data transmission quality may be selected from existing indexes for evaluating a network path as the network quality parameter. Common existing indexes for evaluating a network path may include a delay parameter, a packet loss rate parameter, a network bandwidth parameter, and a jitter parameter. The delay parameter may indicate time of transmitting data from the terminal to the server by using the network path. The packet loss rate parameter may reflect a case that the network path fails to transmit data from the terminal to the server and a data loss is caused. The network bandwidth parameter may be a highest data rate that may be passed by the network path. The jitter parameter may be a time difference between a maximum delay and a minimum delay of the network path. In an actual application, the delay parameter, the packet loss rate parameter, and the network bandwidth parameter can reflect the data transmission performance of the network path more intuitively. The delay parameter, the packet loss rate parameter, and the network bandwidth parameter may be used as network quality parameters for determining the network quality.

An example in which the network quality parameter may include the delay parameter, the packet loss rate parameter, and the network bandwidth parameter is used. A mode of determining the network quality according to the delay parameter, the packet loss rate parameter, and the network bandwidth parameter is not limited in some embodiments.

In an actual application, when a packet loss occurs, retransmission is performed. The retransmission means that time for the server to receive all data may be longer, and it may be initially considered that the network quality is reduced. During actual data transmission, a duration for transmitting all data is further related to the network bandwidth parameter. When the network quality is determined, a delay caused by the retransmission may be first determined, and then an actual network quality is determined with reference to the network bandwidth parameter.

During implementation, the computer device may first determine an actual delay parameter corresponding to the network path according to the delay parameter and the packet loss rate parameter. The actual delay parameter refers to time used by the network path to successfully transmit all data transmitted by the terminal to the server to the server. The actual delay parameter may be positively correlated to the delay parameter, and the actual delay parameter may be positively correlated to the packet loss rate parameter. For example, when the delay parameter is specified, a larger packet loss rate parameter corresponds to a larger actual delay parameter. When the packet loss rate parameter is specified, a larger delay parameter corresponds to a larger actual delay parameter. Next, the computer device may determine, according to the network bandwidth parameter and the actual delay parameter, the network quality corresponding to the network path. The network quality may be positively correlated to the network bandwidth parameter, and the network quality may be negatively correlated to the actual delay parameter. For example, when the network bandwidth parameter is specified, a larger actual delay parameter corresponds to a poorer network quality and less favorable data transmission. When the actual delay parameter is specified, a larger network bandwidth parameter corresponds to a higher network quality and more favorable data transmission.

In an actual application, the delay parameter may be represented by using round-trip time (RTT), the packet Loss rate parameter may be represented by using Loss, and the network bandwidth parameter may be represented by using BandWith. Correspondingly, the process of determining the actual delay parameter according to RTT and Loss may be implemented by using the following formula:

$$RealRTT = \frac{RTT}{1 - Loss}$$

In the foregoing formula, RealRTT may represent the actual delay parameter, RTT may represent the delay parameter, and Loss may represent the packet loss rate parameter.

The process of determining, according to BandWith and RealRTT, the network quality corresponding to the network path may be implemented by using the following formula:

$$PathQuality = \frac{BandWith}{RealRTT}$$

In the foregoing formula, PathQuality may represent the network quality, BandWith may represent the network bandwidth parameter, and RealRTT may represent the actual delay parameter.

Existing indexes of the network path such as the delay parameter, the packet loss rate parameter, and the network bandwidth parameter may be quantized and converted into the network quality, to evaluate the data transmission performance of the network path. In an actual application, the delay parameter, the packet loss rate parameter, and the network bandwidth parameter may be input into the foregoing network quality evaluation model. The delay parameter, the packet loss rate parameter, and the network bandwidth parameter are quantized based on the foregoing two formulas by using the network quality evaluation model, and are converted into the network quality. The network quality PathQuality may be a value. It may be more intuitive and convenient to evaluate and compare the data transmission performances of a plurality of network paths.

According to some embodiments, setting of the network quality parameter and the mode of determining the network quality according to the network quality parameter are described. The mode of obtaining the network quality parameter is not limited, and the following descriptions are merely provided as examples.

When a communication connection is established between the terminal and the server, the two parties may maintain a transmission path session (which may be, for example, a Session) of the communication connection in a transport layer cache, so that a network interface of the terminal establishes a connection to a network port of the server. When data is to be transmitted, the transmission path session may be directly used. In an actual application, for a network path, if the terminal already transmits data to the server by using the network path, it may be considered that the transmission path session of the network path correspondingly exists. In some embodiments, the computer device may obtain the network quality parameter in a passive obtaining mode. In the presence of a transmission path session of the network path, the terminal may obtain the network quality parameter of the network path from session information corresponding to the transmission path session. For a network path on which a transmission path session already exists, the network quality parameter may be obtained from session information corresponding to the transmission path session, which is convenient and highly efficient.

In an actual application, for a network path, there may be a case that no transmission path session is not maintained, for example, a case that the terminal has not transmitted data to the server by using the network path all the time, or the network path is a path newly added in the data transmission process. In some embodiments, the computer device may obtain the network quality parameter in an active probing mode. In the absence of a transmission path session of the network path, the terminal may establish a connection to the server using the network path. The terminal may transmit a detection data packet to the server using the network path. The detection data packet may be a data packet (for example, heartbeat data) constructed to detect the network quality parameter of the network path. After the detection data packet is transmitted, the transmission path session of the network path may be correspondingly established. Because the session information corresponding to the transmission path session may be updated in the data transmission process and correspondingly, the session information corresponding to the transmission path session of the network path may be updated in the process of transmitting the detection data packet, the terminal may obtain the network quality parameter of the network path from the session information corresponding to the transmission path session. For a network path in which there is no transmission path session, the transmission path session may be established by transmitting a detection data packet. The network quality parameter is obtained from session information, to ensure reliability of the obtained network quality parameter.

203: Determine a second network path from the network path list according to the network quality corresponding to each network path in the network path list.

204: Transmit, by the terminal, the target data using the second network path.

After completing determining the network quality corresponding to each network path in the network path list, the computer device may determine the second network path from the network paths according to the network quality corresponding to each network path. The computer device may transmit the target data by using the second network path through the terminal. The network quality corresponding to the second network path satisfies the data transmission condition. The data transmission condition may be configured for evaluating whether the data transmission performance of the network path can ensure the data transmission quality. The second network path satisfying the data transmission condition indicates that the data transmission performance of the second network path may ensure the data transmission quality. Transmission of the target data using the second network path can ensure the data transmission quality.

It can be seen from the foregoing technical solutions that, in a process of transmitting, by a terminal, target data to a server using a first network path, a network path list of the terminal may be first obtained. The network path list may include a plurality of network paths. The plurality of network paths may include a first network path. The plurality of network paths may be network paths corresponding to network interfaces that are already enabled on the terminal. The plurality of network paths may be configured for supporting the terminal to transmit the target data to the server. For each network path, a network quality corresponding to the network path may be determined. The network quality is configured for representing a data transmission performance of the network path. A second network path having the network quality satisfying a data transmission condition may be determined from the network paths according to the network qualities respectively corresponding to the network paths in the network path list. The target data is transmitted by the terminal using the second network path. The network quality corresponding to the second network path satisfies the data transmission condition. The data transmission condition is configured for evaluating whether the data transmission performance of the network path can ensure the data transmission quality. The second network path satisfying the data transmission condition indicates that the data transmission performance of the second network path may ensure the data transmission quality. Transmission of the target data using the second network path can ensure the data transmission quality. It can be seen that in a data transmission process, a network path adaptive decision method based on a network quality is provided, which means that a second network path having a network quality satisfying a data transmission condition is determined from a plurality of network paths based on the network quality, and then the network path for transmitting target data is adjusted to the second network path. Data transmission can be performed by using a network path satisfying a data transmission condition, thereby improving data transmission quality.

The mode of determining the second network path from the network path list is not limited. Making network path adaptive decisions based on the network quality may help ensure data transmission quality. A network path adaptive decision is made in the process of transmitting the target data by using the first network path in two cases: the network quality of the first network path can ensure the data transmission quality, and the network quality of the first network path cannot ensure the data transmission quality. The following mode of determining the second network path is an example with respect to these cases.

In some embodiments, if it is determined that the network quality corresponding to the first network path satisfies the data transmission condition, it indicates that the first network path can ensure the data transmission quality. At this moment, the first network path may be determined as the second network path. In a case that the network quality of the first network path can ensure the data transmission quality, a result of making a network path adaptive decision may be to continue to use the first network path to transmit the target data. When it is determined, based on the network quality, that the first network path can ensure the data transmission quality, the target data may continue to be transmitted by using the first network path, thereby avoiding network path switching, and correspondingly reducing occurrence of a problem that may be caused by the network path switching.

In some embodiments, if it is determined that the network quality corresponding to the first network path does not satisfy the data transmission condition, it indicates that the first network path cannot ensure the data transmission quality. At this moment, a network path adaptive decision may be made. In an actual application, a user corresponding to a terminal may autonomously configure a network path policy of the terminal. Different users may self-define the network path policy according to their requirements, which is beneficial to improving user experience. The network path policy is a policy based on which a network path for transmitting data is decided. For example, the network path policy may include single-path transmission, multipath transmission, and path maintenance. Under different network path policies, modes of making a network path adaptive decision may be different. The network path policy configured by the user may affect a implementation of making a network path adaptive decision. A process of making a network path adaptive decision is matched with an intention of the user, which is also beneficial to improving user experience. In an actual application, if it is determined that the network quality corresponding to the first network path does not satisfy the data transmission condition, the second network path may be determined from the network paths according to the network path policy of the terminal and the network quality corresponding to each network path. In a case that the first network path cannot ensure the data transmission quality, a network path adaptive decision may be made based on the network path policy and the network quality, to determine the second network path. Because the network path policy is autonomously configured by the user, it can be ensured that a result of making the network path adaptive decision meets an expectation of the user. It is ensured that the determined second network path is matched with an intention of the user, thereby improving user experience.

Content of the data transmission condition and a mode of determining the second network path are not limited. When the content of the data transmission condition and the content of the network path policy are different, modes of determining the second network path may be different.

The data transmission condition may be set by directly using the network quality, to more conveniently evaluate whether the network quality of the network path satisfies the data transmission condition. A network quality threshold may be preset. The network quality threshold may be a minimum value of the network quality that can reflect the ensured data transmission quality, and can be configured for evaluating the network quality. If the network quality of the network path is less than the network quality threshold, it is considered that the network quality of the network path is poor, even the network path is unavailable, and it is difficult to ensure the data transmission quality. If the network quality of the network path is greater than or equal to the network quality threshold, it is considered that the network quality of the network path is good, and the data transmission quality can be ensured.

In some embodiments, if the network quality corresponding to the first network path is less than the network quality threshold, it may be determined that the network quality corresponding to the first network path does not satisfy the data transmission condition. If the network path policy is single-path transmission, it indicates that the user intends to transmit data based on one network path. At this moment, network paths other than the first network path in the plurality of network paths may be first used as to-be-determined network paths. A to-be-determined network path having the highest network quality is determined as the second network path, where the network quality corresponding to the second network path is greater than or equal to the network quality threshold. There is one second network path and the second network path has the best network quality. It is ensured that under the network path policy of single-path transmission, there is one network path for simultaneously transmitting the target data, which is beneficial to saving bandwidth and the like. The network quality of the network path is the best, which is beneficial to improving the data transmission quality of the target data.

The data transmission condition may be set indirectly by using the network quality, to comprehensively evaluate, from other dimensions, whether the network quality of the network path satisfies the data transmission condition. In actual data transmission, when different target data is transmitted, transmission efficiency may have different requirements. For example, when the user transmits data stored in the terminal to the server for cloud storage, to release memory of the terminal, a requirement on transmission efficiency is relatively low. When the network quality is different, transmission efficiency that can be provided when data is transmitted varies. Corresponding transmission efficiency may be first determined according to the network quality, and then whether the network quality of the network path satisfies the data transmission condition is evaluated by using the transmission efficiency. For example, for any data that is being transmitted, a requirement of the data for transmission efficiency may be reflected by using a transmission efficiency threshold of the data. The requirement may be an actual requirement for real-time property, bandwidth, and the like. If the transmission efficiency provided by a network path for transmitting the data is less than the transmission efficiency threshold of the data, it indicates that the network path cannot satisfy the requirement of the data for the transmission efficiency, and it can be determined that the network quality of the network path does not satisfy the data transmission condition, and vice versa.

Correspondingly, in some embodiments, the computer device may determine, according to the network quality corresponding to the first network path, transmission efficiency of the first network path for the target data. If the transmission efficiency of the first network path for the target data is less than a transmission efficiency threshold of the target data, it indicates that the transmission efficiency provided by the first network path cannot satisfy a requirement of the target data for the transmission efficiency. At this moment, it may be determined that the network quality corresponding to the first network path does not satisfy the data transmission condition. If the network path policy is multipath transmission, it indicates that the user can accept to simultaneously transmit data through a plurality of network paths. At this moment, the computer device may obtain a data size of the target data. The computer device may screen, according to the data size of the target data and the network quality corresponding to each network path, network paths of a target quantity from the network paths as the second network paths. The target quantity is an integer greater than 1, and a comprehensive transmission efficiency of the second network paths of the target quantity for the target data is greater than or equal to the transmission efficiency threshold. The comprehensive transmission efficiency for the target data herein refers to data transmission efficiency when the target data is transmitted in parallel by the plurality of second network paths. The quantity of second network paths is greater than one. The target data is transmitted through a plurality of network paths thereby ensuring that a requirement of the target data for data efficiency can be satisfied. For a scene in which the target data is relatively large, a multipath simultaneous transmission mode may be used to satisfy a requirement of the target data for transmission efficiency, thereby ensuring the data transmission quality.

In a case that the quantity of second network paths is greater than one, the mode of determining the second network path according to the data size of the target data and the network quality corresponding to each network path and transmitting the target data by the terminal using the second network path is not limited in some embodiments.

In an actual application, when the target data is simultaneously transmitted by using a plurality of second network paths, if a transmission speed of a second network path is relatively low, the server can aggregate, sort, and recombine all received data to determine that the target data is received after the data transmitted by the network path having the relatively low transmission speed arrives. This clearly affects the transmission efficiency of the target data. This problem may be referred to as a slow path congestion problem. When the quantity of second network paths is greater than one, the slow path congestion problem may be considered. When the second network path is determined, a difference between data transmission capabilities provided by a plurality of network paths may be considered, so that data transmission capabilities of any two of the second network paths are not greatly different, thereby avoiding the slow path congestion problem.

During implementation, the computer device may first determine a target quantity according to the data size of the target data. The computer device may determine a network quality difference between every two of the network paths according to the network qualities respectively corresponding to the network paths. The network quality difference can reflect a difference between data transmission capabilities of two network paths. Finally, the computer device may screen, from the network paths having the network quality difference less than a quality difference threshold, the network paths of the target quantity as the second network paths. The quality difference threshold may be configured for reflecting an allowed upper limit of the difference between the data transmission capabilities of the two network paths. The difference between the data transmission capabilities of the two network paths having the network quality difference less than the quality difference threshold is within an acceptable range, and the transmission efficiency of the target data is not significantly affected. Second network paths of a target quantity having data transmission capabilities greatly different from each other can be selected from the plurality of network paths, and the quantity of the second network paths is determined according to the data size of the target data. This facilitates subsequent transmission of the target data by using the second network paths of the target quantity, properly allocates a transmission resource, and ensures better transmission efficiency.

In a case that the quantity of second network paths is greater than one, some embodiments further provide a implementation of transmitting the target data by the terminal using the second network paths. The computer device may first partition the target data into data packets of a target quantity. For each data packet, the terminal may use one of the second network paths of the target quantity for transmission. Different data packets correspond to different second network paths. One second network path may be used to be responsible for transmitting one data packet of the target data, thereby effectively avoiding occurrence of data transmission congestion.

In a case that the quantity of second network paths is greater than one, whether the second network paths include the first network path is not limited in some embodiments. If the transmission efficiency of the first network path does not satisfy the transmission efficiency threshold but the first network path can satisfy the foregoing related condition (for example, the network quality difference is less than the quality difference threshold) for screening the second network path, the second network path may include the first network path. Although the transmission efficiency requirement cannot be satisfied by using the first network path alone, after an adaptive decision is made, both the another network path and the first network path are responsible for transmission of the target data, thereby satisfying the transmission efficiency requirement. If the transmission efficiency of the first network path does not satisfy the transmission efficiency threshold and the first network path also does not satisfy the foregoing related condition for screening the second network path, the second network path does not include the first network path, which is beneficial to improving the data transmission quality.

In some embodiments, if it is determined that the network quality corresponding to the first network path does not satisfy the data transmission condition and the network path policy is path maintenance, it indicates that the user hopes not to perform path switching. At this moment, the computer device may use the first network path as the second network path. The network path adaptive decision is matched with the intention of the user.

In a case that the first network path does not satisfy the data transmission condition and the network path policy is path maintenance, the data transmission quality may be reduced. At this moment, the computer device may generate policy switching prompt information, and display the policy switching prompt information to the user by using the terminal, to prompt the user to adjust the network path policy in time. For example, the policy switching prompt information may be “The current data transmission quality is poor, and you can adjust the network path policy to single-path transmission or multipath transmission”. If the user adjusts the network path policy from path maintenance to single-path transmission or multipath transmission through a corresponding operation in response to the policy switching prompt information, the terminal may feed back the adjusted network path policy to the computer device in response to the operation of the user, so that the computer device re-determines a second network path according to the adjusted network path policy, to provide a better data transmission service for the user.

An execution time of the network path adaptive decision method based on a network quality provided in some embodiments is not limited in some embodiments. In some embodiments, the method may be performed in real time in a data transmission process, which is beneficial to ensuring the data transmission quality to the greatest extent. In some embodiments, the method may be performed regularly in a data transmission process. The method may be performed at regular intervals, which is beneficial to saving computing resources. For example, operation 201 may be started to be performed at regular intervals in a mode of setting a timed task.

In actual data transmission, emergencies may occur. These emergencies directly affect transmission of the target data. In some embodiments, an instant response may be made to the emergencies by re-performing the operation of determining a network quality corresponding to each network path in the network path list in operation 202. During implementation, the computer device may re-perform, in response to a target instruction in the process of transmitting the target data, the operation of determining a network quality corresponding to each network path in the network path list. The target instruction may be an instruction generated corresponding to an emergency. The emergency may include network path switching, network path reconnection, data transmission congestion, and the like. For example, in the process of transmitting target data, the user closes a WiFi network interface and opens a Cellular network interface. At this moment, it may be considered that the emergency of network path switching occurs. If a WiFi network path is disconnected and reconnected due to factors such as unstable WiFi signals, it may be considered that the emergency of network path reconnection occurs. If the WiFi network path on which data is being transmitted is loaded with transmission of a plurality of data at the same time, resulting in reduced data transmission quality, it may be considered that the emergency of data transmission congestion occurs. When the foregoing emergencies occur, a corresponding network path switching instruction, network path reconnection instruction, and data transmission congestion instruction may be generated. Correspondingly, the target instruction may include at least one of a network path switching instruction, a network path reconnection instruction, and a data transmission congestion instruction. In the process of transmitting target data, once an emergency that can affect target data transmission occurs, an instant response can be made, which is beneficial to improving the data transmission quality.

For some embodiments using timed execution, making an instant response to an emergency may be considered as supplementary to an execution time of the network path adaptive decision method. For example, the second network path is determined after one round of timed task is executed, and a next round of timed task is not reached. In this process, once an emergency occurs, the foregoing target instruction may be responded in real time to avoid impact of the emergency on the data transmission quality.

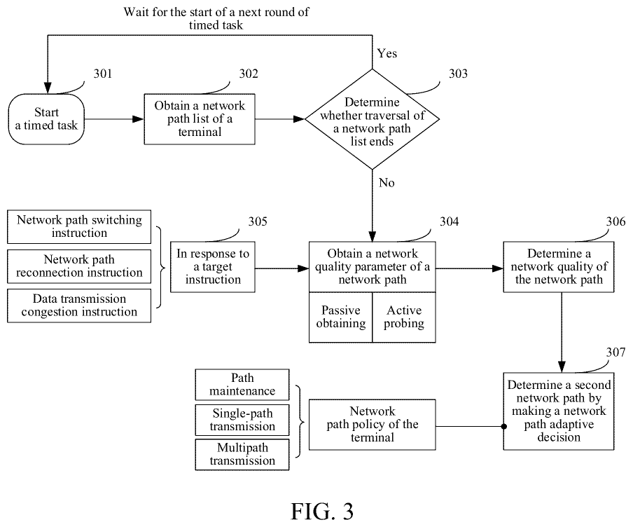

For additional implementation details of using timed execution in combination with an instant response to an emergency, some embodiments further provide a schematic diagram of execution logic of a data transmission method. For details, refer to FIG. 3. FIG. 3 shows a schematic diagram of execution logic of a data transmission method. The method includes the following operations.

301: Start a timed task.

In an actual application, subsequent operations may be started to be performed at regular intervals in a mode of setting a timed task.

302: Obtain a network path list of a terminal.

After a round of timed task is started, operation 302 may be performed. The network path list may include a network path of a network interface that is already enabled on the terminal. A plurality of network paths corresponding to the terminal may be determined.

303: Determine whether traversal of the network path list ends.

304: Obtain a network quality parameter of a network path.

After the network path list is obtained, the network path list may be traversed, so that for each network path in the network path list, operation 304 is performed, to obtain the corresponding network quality parameter. When the traversal of the network path list does not end yet, it indicates that a network path of which a network quality parameter is not obtained in 304 exists in the network list. At this moment, operation 303 and operation 304 further may be performed until traversal of the network path list ends, and a next round of timed task may be started. In an actual application, a mode of performing operation 304 may be passive obtaining or active probing.

305: Trigger operation 304 in response to a target instruction.

The target instruction may be an instruction generated corresponding to an emergency. For example, FIG. 3 shows three types: a network path switching instruction (a corresponding emergency is network path switching), a network path reconnection instruction (a corresponding emergency is network path reconnection), and a data transmission congestion indicator (a corresponding emergency is data transmission congestion). In a waiting process in which a round of timed task is completed and a next round of timed task is started, operation 304 is triggered to be performed by using a target instruction generated for an instant response from an emergency, to avoid a problem that the data transmission quality is reduced in the waiting process.

306: Determine a network quality of the network path.

After the network quality parameter is obtained, the network quality of the network path may be determined according to the network quality parameter, to evaluate a data transmission performance of the network path by using the network quality.

307: Determine a second network path by making a network path adaptive decision.

Finally, the network path adaptive decision may be made, to determine the second network path. After the network path adaptive decision is made, the target data may be subsequently transmitted by using the second network path. When the network path adaptive decision is made, not only reference may be made to the network quality determined in operation 306, but also a network path policy of the terminal that is autonomously configured by a user may be considered. For example, when it is determined, based on the network quality, that network path switching may be performed, the second network path may be further determined with reference to the network path policy, so that the process of making a network path adaptive decision is matched with an intention of the user, thereby improving user experience. FIG. 3 shows three network path policies: path maintenance, single-path transmission, and multipath transmission. In an actual application, different network path policies reflect different intentions of the user, and correspondingly, the second network paths determined by decision are different.

Because this may correspond to the method embodiments, for additional implementation details, refer to the descriptions of the method according to some embodiments.

According to some embodiments, a process of transmitting, by a terminal, target data to a server is described in detail. In an actual application, the server may transmit data to the terminal.

After receiving the target data transmitted by the terminal, the server may transmit corresponding response data to the terminal, to notify a user using the terminal of a transmission state of the target data. During implementation, the computer device may transmit the response data corresponding to the target data to the terminal by the server using a first target path. The first target path may include a first network path and/or a second network path. The server receives the target data from network paths, and correspondingly, the server may transmit the response data corresponding to the target data to the terminal through these network paths. A function of the response data may be informing the user using the terminal of a transmission state of the target data (for example, the transmission state may be successful transmission).

In an actual application, the server may further actively transmit push data to the terminal, to present the push data to the user using the terminal. For example, the terminal may not transmit data to the server for a relatively long period of time, and the terminal does not disconnect from a communication connection to the server. At this moment, the server may actively transmit the push data to the terminal. During implementation, the computer device may transmit the push data to the terminal by the server using a second target path. The second target path may include a network path, in the network path list, on which a transmission path session exists. If the transmission path session exists, it may be considered that the terminal transmits data to the server by using the network path. When actively transmitting the push data, the server may transmit the push data to the terminal through the network path on which the transmission path session exists.

In the foregoing described embodiment, the mode of establishing a communication connection between the terminal and the server is not limited in some embodiments.

In an actual application, a communication connection may be established between the terminal and the server based on a data transmission protocol. Common data transmission protocols may include a transmission control protocol (TCP), a user datagram protocol (UDP), a low delay transport layer (Quick UDP Internet Connection (QUIC)) protocol, and the like.

The TCP is a reliable transmission protocol. The UDP is an unreliable transmission protocol. An application may implement reliable data transmission. The QUIC protocol is a reliable transmission protocol developed based on the UDP. Different data transmission protocols have different performances during data transmission. To obtain good data transmission quality, the data transmission quality may be improved by using an idea of congestion control. The congestion control refers to fairly and maximally using a channel of a network path by controlling a data transmitting policy of a data transmitter (for example, the foregoing terminal). For example, for the TCP, a congestion control algorithm of the TCP may be optimized to improve the data transmission quality. For example, when a bottleneck bandwidth and RTT (BBR) algorithm is used as the congestion control algorithm, relatively good data transmission quality can be maintained when the packet loss rate parameter is 10%. A multipath TCP (MPTCP) solution may be used. Based on the MPTCP solution, a plurality of network paths may be allowed to be used for one TCP connection to maximize use of channel resources in a sub-connection mode. For another example, for the QUIC protocol, a stream control mechanism and the like may be used to improve the data transmission quality.

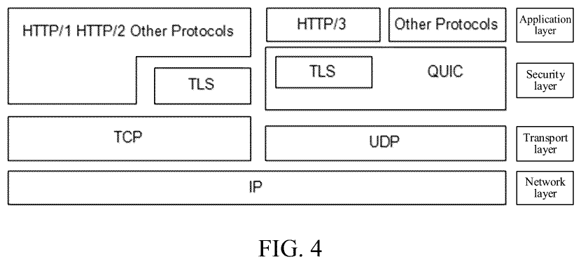

In some embodiments, the TCP and the QUIC protocol are used as an example. A schematic diagram of a protocol hierarchy of a TCP and a QUIC protocol is provided. For details, refer to FIG. 4. FIG. 4 shows a schematic diagram of a protocol hierarchy of a TCP and a QUIC protocol. The protocol hierarchy may be considered as including a network layer, a transport layer, a security layer, and an application layer from bottom to top.

The network layer may be configured for configuring an Internet protocol (IP), and may mainly provide information about various protocols (for example, a TCP and a UDP) to the transport layer.

The transport layer is a data transmission protocol. In the protocol hierarchy of the TCP, the transport layer is the TCP. In the protocol hierarchy of the QUIC protocol, the transport layer is the UDP.

For the security layer, in the protocol hierarchy of the TCP, a transport layer security (TLS) may be used. The TLS may be configured for providing secrecy and data integrity in a data communication process, so that the TCP is reliable. When the QUIC protocol is developed based on the UDP, to ensure that the QUIC protocol is reliable, TLS may be used in the protocol hierarchy of the QUIC protocol. The QUIC protocol uses the TLS as a mandatory option. By means of an authenticated header and data encryption, secrecy and data integrity are ensured, so that reliability of the QUIC protocol is equivalent to that of the TCP. In addition to the TLS, the QUIC protocol further integrates other desirable features in the TCP, for example, a TCP option that allows non-consecutive segments to be separately confirmed, for example, a selective acknowledge character (SACK), a forward acknowledge character (FACK), two retransmission methods, for example, fast retransmission (FR) and early retransmission (ER), a tail loss probe (TLP), a retransmission time out (RTO), a forward RTO-recovery (F-RTO), and a transmitting rate control Pacing mechanism. The FACK may predict packet loss information by recording a SACK having a largest sequence number in the SACKs. The TPL may trigger the FR. The F-RTO may provide a recovery mechanism for retransmission timeout of the RTO. The Pacing mechanism may prevent a quantity of data packets from bursting. Based on these ideas, a rich pluggable congestion control policy may be provided, to facilitate flexible congestion control. The QUIC protocol may further provide abundant information for these congestion control policies to use. For example, regardless of an original packet or a retransmission packet, each data packet may carry a new sequence number seq. A transmitting party can distinguish whether an ACK belongs to the retransmission packet or the original packet, thereby avoiding TCP retransmission ambiguity and RTO problems caused by lost retransmission. An ACK in the QUIC protocol carries a delay from receiving a data packet to replying to the ACK. The RTT can be accurately calculated with reference to sequence numbers of data packets that are increased. The RTT calculated by using the QUIC protocol is more accurate, which is beneficial to improving the accuracy of the RealRTT, so that the network quality determined in some embodiments is more accurate.

For the application layer, in the protocol hierarchy of the TCP, data streams based on HTTP/1, HTTP/2, and other protocols of a hyper text transfer protocol (HTTP) may be provided. In the protocol hierarchy of the QUIC protocol, data flows of HTTP/3 and other protocols may be provided. In an actual application, packet loss and stream control of the QUIC protocol are implemented based on streams, and the streams are independent of each other. A packet is lost in one Stream, and data transmission of another Stream is not affected.

In terms of stream control, for example, in the TCP, stream control is to control a data transmitting policy of a data transmitter (for example, the foregoing terminal), to fairly and maximally use a channel of a network path. For example, congestion control is triggered according to a condition of packet loss or RTT increase, to control data transmitting. The congestion control of the QUIC protocol uses stream control of a stream level and a connection level. A data receiver (for example, the foregoing server) may transmit a stream control frame (for example, a WINDOW_UPDATE frame) to notify the data transmitter (for example, the foregoing terminal) that the size of a data receiving window increases, for example, notify the data transmitter that “I can receive more data”. The QUIC protocol further considers a data receiving capability of the data receiver (for example, the foregoing server). Correspondingly, the data transmitter may transmit a stream control frame (for example, a BLOCKED frame) to notify the data receiver that data transmitting is restricted by the data receiving window of the data receiver, and data cannot be transmitted. For example, the data receiver may be notified that “I want to transmit data, but the channel is out of a congestion state”. The QUIC protocol may implement stream control by using the stream control frames WINDOW_UPDATE frame and BLOCKED frame, to adjust data windows of Stream and Connection levels. It may be considered that the QUIC protocol can implement independent stream control.

In terms of a communication connection, the TCP is established based on a quintuple. When a network path for transmitting data changes, the terminal and the server may reestablish a communication connection and then perform data transmission. The process of establishing a communication connection based on the QUIC protocol may include TCP 3-handshake+TLS handshake, and a total of three RTTs are generated. After the connection is established, the terminal and the server may maintain a Session of a logical connection between the terminal and the server in a transport layer cache of the QUIC protocol, and maintain the logical connection between the terminal and the server by using a 64-bit connection identity document (CID). When a network path for transmitting data changes, a UDP on the transport layer is affected, and a logical connection based on the QUIC protocol keeps unchanged. A communication connection between the terminal and the server is not affected. Correspondingly, a data packet transmitted based on the QUIC protocol and received by the server can be normally processed. The session information corresponding to the Session may include encryption and decryption context information during data transmission, to facilitate encryption and decryption of transmitted data (for example, target data), thereby improving data security. The session information corresponding to the Session may be updated in a data transmission process.

In terms of optimization and upgrade, both the TCP congestion control algorithm and the MPTCP solution may be implemented in a kernel space of an operating system of the terminal or the server. Correspondingly, if the congestion control algorithm or the MPTCP solution is optimized, the kernel space of the operating system of the terminal or the server may be upgraded, and a user space of the operating system may be adapted. For upgrade of the kernel space, the user may upgrade a kernel system. The QUIC protocol may completely run in the user space of the operating system, so that when optimization and upgrade may be performed, the kernel space may not be upgraded. Optimization is more convenient.

The QUIC protocol is a multiplex security transmission protocol. The QUIC protocol may minimize packet loss, provide stream control, and provide optimization. Using the QUIC protocol may facilitate faster and more secure data transmission. To implement the data transmission method provided in some embodiments, a communication connection may be established between the terminal and the server based on a low delay transport layer (QUIC) protocol, and the target data may be transmitted to the server based on the QUIC protocol by the terminal using the first network path. By using the QUIC protocol, packet loss can be reduced, data transmission congestion can be avoided, optimization and upgrade may be facilitated.

When a communication connection is established between the terminal and the server based on the QUIC Protocol, the network path adaptive decision method provided in some embodiments may be referred to as adaptive X-PATH QUIC (AXP-QUIC) protocol data transmission, where the X-PATH may be, for example, the foregoing second network path. Based on the QUIC protocol, data transmission acceleration can be better implemented by using the network path adaptive decision method provided which is beneficial to improving throughput and robustness of data transmission, to resolve a problem of relatively poor data transmission quality caused by a single-path weak network. The single-path weak network means that data is transmitted by using a single network path, and the network quality of the network path is reduced in a data transmission process. The method may be widely applied to data transmission between the terminal and the server, to improve data transmission quality and provide a better data transmission service for a user.

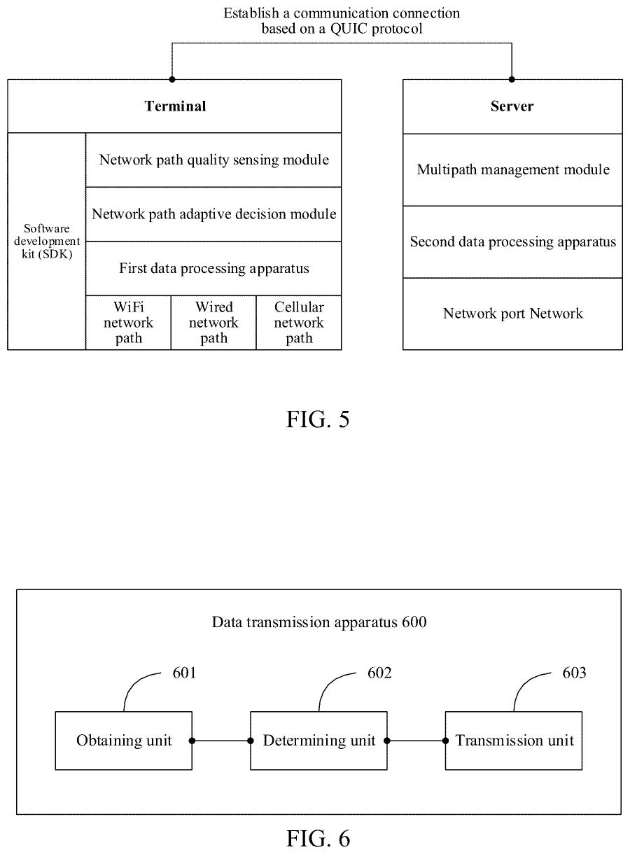

Some embodiments further provide a schematic architectural diagram of an AXP-QUIC system. For details, refer to FIG. 5. FIG. 5 is a schematic architectural diagram of an AXP-QUIC system. In an example shown in FIG. 5, a terminal to perform data transmission can provide support for the foregoing SDK. The SDK may be built in a data transmission application (APP) running on the terminal. The data transmission APP may be configured for transmitting data and support establishment of a communication connection between the terminal and a server based on a QUIC protocol. Descriptions are made in the following with reference to FIG. 5.

An architecture of the terminal is described. A plurality of network paths of the terminal may include three network paths: a WiFi network path, a wired network path, and a Cellular network path. The SDK built in the data transmission APP of the terminal may include a network path quality sensing module, a network path adaptive decision module, and a first data processing module. The network path quality sensing module may be configured to obtain network quality parameters of the WiFi network path, the wired network path, and the Cellular network path, and determine network qualities respectively corresponding to the three network paths. The network path adaptive decision module may be configured to determine a second network path according to the network qualities respectively corresponding to the WiFi network path, the wired network path, and the Cellular network path. The first data processing module may be configured to perform processing such as distribution, aggregation, sorting, and recombination on data. For example, the first data processing module may partition target data into a plurality of data packets, and distribute the data packets by using the second network path, to transmit the target data to the server. Moreover, the first data processing module may aggregate, sort, and recombine response data or push data received from the server, to determine complete data transmitted by the server.

An architecture of the server is described. The server has a network port Network. In an actual application, the server may receive, by using the network port Network, the target data transmitted by the terminal. The server may transmit, by using the network port Network, the response data and the push data to the terminal. Moreover, a multipath management module and a second data processing module may be disposed in the server. The multipath management module may be configured to manage content related to the plurality of network paths of the terminal, and may mainly include maintenance of a transmission path session, addition of network paths, idle timeout deletion, a network path policy of the terminal, selection of a first target path and a second target path, and the like. The addition of network paths may be, for example, that a network interface is newly enabled on the terminal, and a network path is correspondingly added. At this moment, the server may add the network path by using the multipath management module. The idle timeout deletion may be, for example, that duration for which a network path is in an idle state exceeds a preset duration. To release a server resource, the server may delete the network path by using the multipath management module. The second data processing module may be configured to perform processing such as distribution, aggregation, sorting, and recombination on data. For example, the second data processing module may aggregate, sort, and recombine data packets received from the terminal, to determine target data received by the server. Moreover, the second data processing module may distribute response data and push data that may be transmitted to the terminal, to transmit the response data and the push data to the terminal.

The terminal establishes a communication connection to the server based on the QUIC protocol. Whether the terminal transmits the target data to the server or the server transmits the response data or the push data to the terminal is performed based on the QUIC protocol. For example, when distributing data, the first data processing module and the second data processing module may use the foregoing Pacing mechanism, to prevent the quantity of data packets from bursting. For another example, when a network quality parameter of the wired network path is obtained by means of active probing, the network path quality sensing module may establish a QUIC protocol connection to the server by using the wired network path, and transmit, based on the QUIC protocol connection, the detection data packet to the server by using the wired network path. A transmission path session of the wired network path may be established by using the QUIC protocol connection, to facilitate obtaining the network quality parameter of the wired network path from session information corresponding to the transmission path session.

Based on the data transmission method provided in some embodiments corresponding to FIG. 2, some embodiments further provide a data transmission apparatus 600. The data transmission apparatus 600 includes an obtaining unit 601, a determining unit 602, and a transmission unit 603.

The obtaining unit 601 is configured to obtain a network path list of a terminal in a process of transmitting, by the terminal, target data to a server using a first network path, where the network path list includes a plurality of network paths, the plurality of network paths include the first network path, and the plurality of network paths are network paths corresponding to network interfaces that are already enabled on the terminal.

The determining unit 602 is configured to determine a network quality corresponding to each network path in the network path list.

The determining unit 602 is further configured to determine a second network path from the network path list according to the network quality corresponding to each network path in the network path list, where the network quality corresponding to the second network path satisfies a data transmission condition.

The transmission unit 603 is configured to transmit, by the terminal, the target data using the second network path.

In some embodiments, the determining unit may be configured to:
obtain, for each network path in the network path list, a network quality parameter of the network path by the terminal; and determine, according to the network quality parameter of the network path, the network quality corresponding to the network path.

In some embodiments, the determining unit may be configured to:
obtain, in the presence of a transmission path session of the network path, the network quality parameter of the network path from session information corresponding to the transmission path session by the terminal.

In some embodiments, the determining unit may be configured to:
establish, in the absence of a transmission path session of the network path, a connection to the server by the terminal using the network path;
transmit, by the terminal, a detection data packet to the server using the network path, and establish a transmission path session of the network path; and
obtain, by the terminal, the network quality parameter of the network path from session information corresponding to the transmission path session.

In some embodiments, the network quality parameter includes a delay parameter, a packet loss rate parameter, and a network bandwidth parameter. The determining unit may be configured to:
determine, according to the delay parameter and the packet loss rate parameter, an actual delay parameter corresponding to the network path, where the actual delay parameter is positively correlated to the delay parameter, and the actual delay parameter is positively correlated to the packet loss rate parameter; and
determine, according to the network bandwidth parameter and the actual delay parameter, the network quality corresponding to the network path, where the network quality is positively correlated to the network bandwidth parameter, and the network quality is negatively correlated to the actual delay parameter.

In some embodiments, the determining unit may be configured to:
determine, if the network quality corresponding to the first network path satisfies the data transmission condition, the first network path as the second network path.

In some embodiments, the determining unit may be configured to:
determine, if the network quality corresponding to the first network path does not satisfy the data transmission condition, the second network path from the network path list according to a network path policy of the terminal and the network quality corresponding to each network path in the network path list.

In some embodiments, the determining unit may be configured to:
determine, if the network quality corresponding to the first network path is less than a network quality threshold, that the network quality corresponding to the first network path does not satisfy the data transmission condition;
use, if the network path policy is single-path transmission, network paths other than the first network path in the network path list as to-be-determined network paths; and
determine a to-be-determined network path having the highest network quality as the second network path, where the network quality corresponding to the second network path is greater than or equal to the network quality threshold.

In some embodiments, the determining unit may be configured to:
determine, if a transmission efficiency of the first network path for the target data is less than a transmission efficiency threshold of the target data, that the network quality corresponding to the first network path does not satisfy the data transmission condition, where the transmission efficiency is determined according to the network quality corresponding to the first network path;
obtain, if the network path policy is multipath transmission, a data size of the target data; and
screen, according to the data size of the target data and the network quality corresponding to each network path, network paths of a target quantity from the network path list as the second network paths, where the target quantity is an integer greater than 1, and a comprehensive transmission efficiency of the second network paths of the target quantity for the target data is greater than or equal to the transmission efficiency threshold.

In some embodiments, the determining unit may be configured to:
determine the target quantity according to the data size of the target data;
determine, according to the network quality corresponding to each network path, a network quality difference between every two of the network paths; and
screen, from the network paths having the network quality difference less than a quality difference threshold, the network paths of the target quantity as the second network paths.

In some embodiments, the transmission unit may be configured to:
partition the target data into data packets of the target quantity; and
transmit, by the terminal, each data packet using one second network path in the second network paths of the target quantity, where different data packets correspond to different second network paths.

In some embodiments, the determining unit may be configured to:
use the first network path as the second network path if the network quality corresponding to the first network path does not satisfy the data transmission condition and the network path policy is path maintenance.

In some embodiments, the apparatus further includes an establishing unit.

The establishing unit is configured to establish a communication connection between the terminal and the server based on a low delay transport layer (Quick UDP Internet Connection, QUIC) protocol.

The transmission unit is further configured to transmit, by the terminal, the target data to the server using the first network path based on the QUIC protocol.

In some embodiments, the apparatus further includes an execution unit.

The execution unit is configured to re-perform, in response to a target instruction in the process of transmitting the target data, the operation of determining a network quality corresponding to each network path in the network path list, where the target instruction includes at least one of a network path switching instruction, a network path reconnection instruction, and a data transmission congestion instruction.

In some embodiments, the transmission unit is further configured to:
transmit, by the server, response data corresponding to the target data to the terminal using a first target path, where the first target path includes the first network path and/or the second network path;
or, transmit, by the server, push data to the terminal using a second target path, where the second target path includes a network path, in the network path list, on which a transmission path session exists.

It can be seen from the foregoing technical solutions that, in a process of transmitting, by a terminal, target data to a server using a first network path, a network path list of the terminal may be first obtained. The network path list may include a plurality of network paths. The plurality of network paths may include a first network path. The plurality of network paths may be network paths corresponding to network interfaces that are already enabled on the terminal. The plurality of network paths may be configured for supporting the terminal to transmit the target data to the server. For each network path, a network quality corresponding to the network path may be determined. The network quality is configured for representing a data transmission performance of the network path. A second network path having the network quality satisfying a data transmission condition may be determined from the network paths according to the network qualities respectively corresponding to the network paths in the network path list. The target data is transmitted by the terminal using the second network path. The network quality corresponding to the second network path satisfies the data transmission condition. The data transmission condition is configured for evaluating whether the data transmission performance of the network path can ensure the data transmission quality. The second network path satisfying the data transmission condition indicates that the data transmission performance of the second network path ensures the data transmission quality. Transmission of the target data using the second network path can ensure the data transmission quality. It can be seen that in a data transmission process, a network path adaptive decision method based on a network quality is provided, which means that a second network path having a network quality satisfying a data transmission condition is determined from a plurality of network paths based on the network quality, and then the network path for transmitting target data is adjusted to the second network path. Data transmission can be performed by using a network path satisfying a data transmission condition, thereby improving data transmission quality.

According to some embodiments, each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Some embodiments further provide a computer device. The computer device may be a terminal. The terminal is, for example, a smartphone.

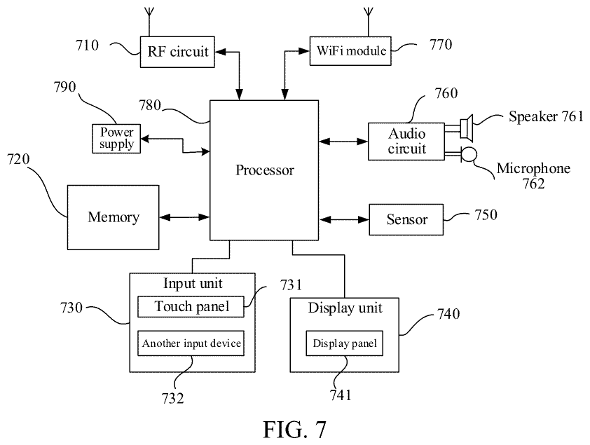

FIG. 7 shows a block diagram of a structure of a part of a smartphone according to some embodiments. Referring to FIG. 7, the smartphone includes: a radio frequency (Radio Frequency, RF) circuit 710, a memory 720, an input unit 730, a display unit 740, a sensor 750, an audio circuit 760, a wireless fidelity (WiFi) module 770, a processor 780, a power supply 790, and other components. The input unit 730 may include a touch panel 731 and another input device 732. The display unit 740 may include a display panel 741. The audio circuit 760 may include a speaker 761 and a microphone 762. A person skilled in the art may understand that the structure of the smartphone shown in FIG. 7 does not constitute any limitation on the smartphone. The smartphone may include more or fewer components than those shown in the figure, or some components may be combined, or different component deployments may be used.

The memory 720 may be configured to store a software program and module. The processor 780 runs the software program and module stored in the memory 720, to implement various functional applications and data processing of the smartphone. The memory 720 may mainly include a program storage area and a data storage area. The program storage area may store an operating system, an application for at least one function (for example, a sound playback function and an image playback function), and the like. The data storage area may store data (for example, audio data and a phone book) created according to use of the smartphone. The memory 720 may include a high speed random access memory, and may further include a non-volatile memory, for example, at least one magnetic disk storage device, a flash memory, or another volatile solid-state storage device.

The processor 780 is a control center of the smartphone, is connected to various parts of the entire smartphone by using various interfaces and lines, and executes various functions of the smartphone and processes data by running or executing a software program and/or a module stored in the memory 720 and invoking data stored in the memory 720. In some embodiments, the processor 780 may include one or more processing units. Preferably, an application processor and a modem processor may be integrated into the processor 780. The application processor mainly processes an operating system, a user interface, an application, and the like. The modem processor mainly processes wireless communication. The foregoing modem may either not be integrated into the processor 780.

In some embodiments, the processor 780 in the smartphone may perform the following operations:
obtaining a network path list of a terminal in a process of transmitting, by the terminal, target data to a server using a first network path, where the network path list includes a plurality of network paths, the plurality of network paths include the first network path, and the plurality of network paths are network paths corresponding to network interfaces that are already enabled on the terminal;
determining, for each network path in the plurality of network paths, a network quality corresponding to the network path;
determining a second network path from the plurality of network paths according to the network quality corresponding to each network path, where the network quality corresponding to the second network path satisfies a data transmission condition; and
transmitting, by the terminal, the target data using the second network path.

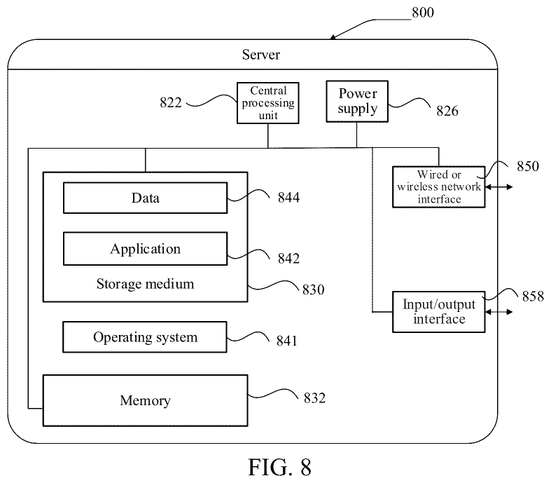

The computer device provided in some embodiments may be a server. Referring to FIG. 8, FIG. 8 is a structural diagram of a server 800 according to some embodiments. The server 800 may vary greatly due to different configurations or performance, and may include one or more processors, for example, central processing units (CPU) 822, a memory 832, and one or more storage media 830 (for example, one or more mass storage devices) that store applications 842 or data 844. The memory 832 and the storage medium 830 may be transient or persistent storages. A program stored in the storage medium 830 may include one or more modules. Each module may include a series of instruction operations on the server. The central processing unit 822 may be configured to communicate with the storage medium 830, and perform, on the server 800, the series of instruction operations on the storage medium 830.

The server 800 may further include one or more power supplies 826, one or more wired or wireless network interfaces 850, one or more input/output interfaces 858, and/or one or more operating systems 841, for example, Windows Server™, Mac OS X™, Unix™, Linux™, or FreeBSD™.

In some embodiments, the operations performed by the central processing unit 822 in the server 800 may be implemented based on the structure shown in FIG. 8.

According to some embodiments, a computer-readable storage medium is provided. The computer-readable storage medium is configured to store a computer program. The computer program is configured for implementing the data transmission method according to some embodiments.

According to some embodiments, a computer program product is provided. The computer program product includes a computer program. The computer program is stored in a computer-readable storage medium. A processor of a computer device reads the computer program from the computer-readable storage medium. The processor executes the computer program, to cause the computer device to perform the method provided in some embodiments of some embodiments.

The terms “first”, “second”, “third”, and “fourth” (if any) are for distinguishing similar objects and not necessarily for describing any particular order or sequence. Data used in this way is exchangeable in a proper case, so that some embodiments described herein can be implemented in an order different from the order shown or described herein. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

In the several embodiments provided the disclosed system, apparatus, and method may be implemented in other modes. For example, the described apparatus embodiment is merely an example. For example, the unit division is merely a logical function division and may be other division during actual implementation. For example, a plurality of units or components may be combined or integrated into another system, or some features may be ignored or not performed. The displayed or discussed mutual couplings or direct couplings or communication connections may be implemented by using some interfaces. The indirect couplings or communication connections between the apparatuses or units may be implemented in electronic, mechanical, or other forms.

When the integrated unit is implemented in the form of a software functional unit and sold or used as an independent product, the integrated unit may be stored in a computer-readable storage medium. Based on such an understanding, some embodiments essentially, or a part contributing to the related art, or all or a part of the technical solution may be implemented in a form of a software product. The computer software product is stored in a storage medium and includes several instructions for instructing a computer device (which may be a computer, a server, a network device, or the like) to perform all or some of operations of the methods in some embodiments. The foregoing storage medium includes: various media capable of storing program codes, such as a USB flash drive, a mobile hard disk, a read-only memory (ROM), a random access memory (RAM), a magnetic disk, or an optical disc.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data transmission method, performed by a terminal, comprising:
obtaining a network path list comprising a plurality of network paths of the terminal, based on the terminal determining to transmit target data to a server via a first network path of the plurality of network paths, wherein the plurality of network paths correspond to network interfaces that are enabled on the terminal;
determining a plurality of network qualities corresponding to the plurality of network paths;
determining a second network path from the network path list according to the plurality of network qualities, wherein one network quality corresponding to the second network path satisfies a data transmission condition; and
transmitting the target data to the server via the second network path.

2. The data transmission method according to claim 1, wherein the determining the plurality of network qualities comprises:
obtaining a plurality of network quality parameters that correspond to the plurality of network paths; and
determining the plurality of network qualities according to the plurality of network quality parameters.

3. The data transmission method according to claim 2, wherein the obtaining the plurality of network quality parameters comprises obtaining, based on a transmission path session of a network path being established, a network quality parameter of the network path, from session information corresponding to the transmission path session.

4. The data transmission method according to claim 2, wherein the obtaining the plurality of network quality parameters comprises:
based on a transmission path session of a network path not being established, establishing a connection to the server via the network path;
transmitting a detection data packet to the server via the network path, and establishing the transmission path session; and
obtaining a network quality parameter of the network path from session information corresponding to the transmission path session.

5. The data transmission method according to claim 2, wherein the plurality of network quality parameters comprises a plurality of delay parameters, a plurality of packet loss rate parameters, and a plurality of network bandwidth parameters, and
wherein the determining the plurality of network qualities:
determining, according to the plurality of delay parameters and the plurality of packet loss rate parameters, a plurality of actual delay parameters corresponding to the plurality of network paths, wherein an actual delay parameter is positively correlated to a delay parameter, and wherein the actual delay parameter is positively correlated to a packet loss rate parameter; and
determining, according to the plurality of network bandwidth parameters and the plurality of actual delay parameters, the plurality of network qualities, wherein a network quality is positively correlated to a network bandwidth parameter, and wherein the network quality is negatively correlated to the actual delay parameter.

6. The data transmission method according to claim 1, wherein the determining the second network path comprises determining the first network path as the second network path based on a network quality corresponding to the first network path satisfying the data transmission condition.

7. The data transmission method according to claim 1, wherein the determining the second network path comprises determining the second network path according to a network path policy of the terminal and the plurality of network qualities based on a first network quality corresponding to the first network path not satisfying the data transmission condition.

8. The data transmission method according to claim 7, wherein the determining the second network path according to the network path policy and the plurality of network qualities comprises:
based on the first network quality being less than a network quality threshold, determining that the first network quality does not satisfy the data transmission condition; and
based on the network path policy being single-path transmission and a second network quality corresponding to the second network path having a highest network quality from among a plurality of remaining network paths other than the first network path, determining the second network quality as being greater than or equal to the network quality threshold.

9. The data transmission method according to claim 7, wherein the determining the second network path according to the network path policy and the plurality of network qualities comprises:
based on a transmission efficiency of the first network path for the target data being less than a transmission efficiency threshold of the target data, determining that the first network quality does not satisfy the data transmission condition, wherein the transmission efficiency is determined according to the first network quality;
based on the network path policy being multipath transmission, obtaining a data size of the target data; and
screening, according to the data size and the plurality of network qualities, a target quantity of the plurality of network paths from the network path list as a plurality of second network paths, wherein the target quantity is an integer greater than 1, and wherein a comprehensive transmission efficiency of the plurality of second network paths is greater than or equal to the transmission efficiency threshold.

10. The data transmission method according to claim 9, wherein the screening the target quantity of the plurality of network paths comprises:
determining the target quantity according to the data size of the target data;
determining, according to the plurality of network qualities, at least one network quality difference between pairs of the plurality of network paths; and
screening, based on the at least one network quality difference, one or more network paths having network quality differences less than a quality difference threshold, as the plurality of second network paths.

11. A data transmission apparatus, configured to perform as a terminal, comprising:
at least one memory configured to store computer program code; and
at least one processor configured to read the program code and operate as instructed by the program code, the program code comprising:
obtaining code configured to cause at least one of the at least one processor to obtain a network path list comprising a plurality of network paths of the terminal, based on the terminal determining to transmit target data to a server via a first network path of the plurality of network paths, wherein the plurality of network paths correspond to network interfaces that are enabled on the terminal;
first determining code configured to cause at least one of the at least one processor to determine a plurality of network qualities corresponding to the plurality of network paths;
second determining code configured to cause at least one of the at least one processor to determine a second network path from the network path list according to the plurality of network qualities, wherein one network quality corresponding to the second network path satisfies a data transmission condition; and
transmission code configured to cause at least one of the at least one processor to transmit the target data to the server via the second network path.

12. The data transmission apparatus according to claim 11, wherein the obtaining code is configured to cause at least one of the at least one processor to:
obtain a plurality of network quality parameters that correspond to the plurality of network paths; and
determine the plurality of network qualities according to the plurality of network quality parameters.

13. The data transmission apparatus according to claim 12, wherein the obtaining code is configured to cause at least one of the at least one processor to obtain, based on a transmission path session of a network path being established, a network quality parameter of the network path, from session information corresponding to the transmission path session.

14. The data transmission apparatus according to claim 12, wherein the obtaining code is configured to cause at least one of the at least one processor to:
based on a transmission path session of a network path not being established, establish a connection to the server via the network path;
transmit a detection data packet to the server via the network path, and establishing the transmission path session; and
obtain a network quality parameter of the network path from session information corresponding to the transmission path session.

15. The data transmission apparatus according to claim 12, wherein the plurality of network quality parameters comprises a plurality of delay parameters, a plurality of packet loss rate parameters, and a plurality of network bandwidth parameters, and
wherein the first determining code is configured to cause at least one of the at least one processor to:
determine, according to the plurality of delay parameters and the plurality of packet loss rate parameters, a plurality of actual delay parameters corresponding to the plurality of network paths, wherein an actual delay parameter is positively correlated to a delay parameter, and wherein the actual delay parameter is positively correlated to a packet loss rate parameter; and
determine, according to the plurality of network bandwidth parameters and the plurality of actual delay parameters, the plurality of network qualities, wherein a network quality is positively correlated to a network bandwidth parameter, and wherein the network quality is negatively correlated to the actual delay parameter.

16. The data transmission apparatus according to claim 11, wherein the second determining code is configured to cause at least one of the at least one processor to determine the first network path as the second network path based on a network quality corresponding to the first network path satisfying the data transmission condition.

17. The data transmission apparatus according to claim 11, wherein the second determining code is configured to cause at least one of the at least one processor to determine the second network path according to a network path policy of the terminal and the plurality of network qualities based on a first network quality corresponding to the first network path not satisfying the data transmission condition.

18. The data transmission apparatus according to claim 17, wherein the second determining code is configured to cause at least one of the at least one processor to:
based on the first network quality being less than a network quality threshold, determine that the first network quality does not satisfy the data transmission condition; and
based on the network path policy being single-path transmission and a second network quality corresponding to the second network path having a highest network quality from among a plurality of remaining network paths other than the first network path, determine the second network quality as being greater than or equal to the network quality threshold.

19. The data transmission apparatus according to claim 17, wherein the second determining code is configured to cause at least one of the at least one processor to:
based on a transmission efficiency of the first network path for the target data being less than a transmission efficiency threshold of the target data, determine that the first network quality does not satisfy the data transmission condition, wherein the transmission efficiency is determined according to the first network quality;
based on the network path policy being multipath transmission, obtain a data size of the target data; and
screen, according to the data size and the plurality of network qualities, a target quantity of the plurality of network paths from the network path list as a plurality of second network paths, wherein the target quantity is an integer greater than 1, and wherein a comprehensive transmission efficiency of the plurality of second network paths is greater than or equal to the transmission efficiency threshold.

20. A non-transitory computer-readable storage medium, storing computer code which, when executed by at least one processor, causes the at least one processor to at least:
obtain a network path list comprising a plurality of network paths of a terminal, based on the terminal determining to transmit target data to a server via a first network path of the plurality of network paths, wherein the plurality of network paths correspond to network interfaces that are enabled on the terminal;
determine a plurality of network qualities corresponding to the plurality of network paths;
determine a second network path from the network path list according to the plurality of network qualities, wherein one network quality corresponding to the second network path satisfies a data transmission condition; and
transmit the target data to the server via the second network path.
